(19) United States
(12) Patent Application Publication
(10) Pub. No.: US 2015/0158522 A1
(43) Pub. Date: Jun. 11, 2015

(54) STEERED WHEEL VISUAL FEEDBACK SYSTEM FOR VARIABLE RATE STEERING SYSTEMS

(71) Applicant: Kevin P. Thayer, Excelsior, MN (US)

(72) Inventor: Kevin P. Thayer, Excelsior, MN (US)

(73) Assignee: EATON CORPORATION, Cleveland, OH (US)

(21) Appl. No.: 14/343,573

(22) PCT Filed: Sep. 7, 2012
(86) PCT No.: PCT/US2012/054143

§ 371 Date: Jun. 25, 2014

Related U.S. Application Data
(60) Provisional application No. 61/532,876, filed on Sep. 9, 2011.

(51) Int. Cl. B62D 5/065; B62D 5/07

(52) U.S. Cl. CPC B62D 5/065; B62D 5/07

(57) ABSTRACT

A steering control system is for use on a vehicle having an operator station including a steering wheel that is turned by an operator of the vehicle to cause a steered wheel of the vehicle to pivot relative to a main body. The steering control system includes a hydraulic cylinder for changing a steered position of the steered wheel in response to movement of the steering wheel. The steering control system also includes a hydraulic circuit arrangement that varies a volume of hydraulic fluid flow provided to the hydraulic cylinder per degree of rotation of the steering wheel based on a rotational speed of the steering wheel. The hydraulic circuit arrangement directs a first volume of hydraulic fluid to the hydraulic cylinder per degree of rotational movement of the steering wheel when the steering wheel is rotated at a first rotational speed, and directs a second volume of hydraulic fluid to the hydraulic cylinder per degree of rotational movement of the steering wheel when the steering wheel is rotated at a second rotational speed. The second rotational speed is larger than the first rotational speed and the second volume of hydraulic fluid being larger than the first volume of hydraulic fluid, wherein the steering control system is more sensitive when the steering wheel is rotated at the second rotational speed than the first rotational speed. The system also includes a sensor for sensing the steered position of the steered wheel, a display positioned at the operator station, the display providing an indication of the steered position of the steered wheel, and a controller that interfaces with the hydraulic circuit arrangement, the sensor and the display.

### CROSS REFERENCE TO RELATED APPLICATIONS

This application is being filed on 7 Sep. 2012, as a PCT International Patent application in the name of Eaton Corporation, a U.S. national corporation, applicant for the designation of all countries except the U.S., and, Kevin P. Thayer, a citizen of the U.S., applicant for the designation of the U.S. only, and claims priority to U.S. Patent Application Ser. No. 61/532,876 filed on 9 Sep. 2011, the disclosure of which is incorporated herein by reference in its entirety.

### INTRODUCTION

Some mobile vehicles do not have line of sight from the operator station/compartment to the steered wheels. Lift trucks, which are typically rear-wheel steered, are good examples. Hydrostatic steering used on such lift trucks typically maintains a correlated relationship between the steering wheel and steered wheel. For example, consider a lift truck that is equipped with a knob on the steering wheel located in the 7:00 position with the steered wheels centered. In a typical hydrostatic steering system, after completing a steering maneuver and re-centering the steered wheels, the steering wheel knob will be very close to the 7:00 position.

If variable rate steering is used in the same application, steering wheel position relative to the steered wheel is no longer correlated. For example, consider a lift truck equipped with variable rate steering system, and again including a knob on the steering wheel in the 7:00 position with the steered wheels centered. In the variable rate steering system, after completing a steering maneuver and centering the steered wheels, the steering wheel knob may not be near 7:00 position. This is undesirable since the steered wheels are not in the line of sight of the operator.

### SUMMARY

In one aspect, the technology relates to a steering control system for use on a vehicle having an operator station including a steering wheel that is turned by an operator of the vehicle to cause a steered wheel of the vehicle to pivot relative to a main body, the steering control system including a hydraulic cylinder for changing a steered position of the steered wheel in response to movement of the steering wheel, the steering control system including: a hydraulic circuit arrangement that varies a volume of hydraulic fluid flow provided to the hydraulic cylinder per degree of rotation of the steering wheel based on a rotational speed of the steering wheel, the hydraulic circuit arrangement directing a first volume of hydraulic fluid to the hydraulic cylinder per degree of rotational movement of the steering wheel when the steering wheel is rotated at a first rotational speed, the hydraulic circuit arrangement directing a second volume of hydraulic fluid to the hydraulic cylinder per degree of rotational movement of the steering wheel when the steering wheel is rotated at a second rotational speed, the second rotational speed being larger than the first rotational speed and the second volume of hydraulic fluid being larger than the first volume of hydraulic fluid, wherein the steering control system is more sensitive when the steering wheel is rotated at the second rotational speed than the first rotational speed; a sensor for sensing the steered position of the steered wheel; a display positioned at the operator station, the display providing an indication of the steered position of the steered wheel; and a controller that interfaces with the hydraulic circuit arrangement, the sensor and the display.

In another aspect, the technology relates to a variable rate steering system for a vehicle having a steering element and at least one wheel actuated by a hydraulic cylinder, the variable rate steering system including: a fluid circuit for translating a rotation of the steering element to the at least one wheel by delivering a volume of hydraulic fluid to the hydraulic cylinder, wherein the fluid circuit delivers a first volume to the hydraulic cylinder based on a first rate of rotation of the steering element, and wherein the fluid circuit delivers a second volume to the hydraulic cylinder based on a second rate of rotation of the steering element, wherein the second volume is greater than the first volume; a wheel position detection element; an indicator; and a controller that interfaces with the wheel position detection element and the indicator.

### BRIEF DESCRIPTION OF THE DRAWINGS

There are shown in the drawings, embodiments which are presently preferred, it being understood, however, that the technology is not limited to the precise arrangements and instrumentalities shown.

FIG. 1 is a schematic diagram of a steering and visual feedback system for a vehicle.

FIG. 2 is a schematic diagram of an indicator.

FIGS. 3A and 3B schematically show another indicator in accordance with the principles of the present disclosure.

FIG. 4 schematically illustrates a vehicle having a steering control system and steered wheel position feedback in accordance with the principles of the present disclosure.

FIG. 5 shows the vehicle of FIG. 4 with the steered wheels in a full right-turn orientation.

FIG. 6 shows the vehicle of FIG. 4 with the steered wheels in a full left-turn orientation.

FIG. 7 shows the vehicle of FIG. 4 with the steering control system in a normal-flow, right-turn mode.

FIG. 8 shows the vehicle of FIG. 4 with the steering control system in an amplified-flow, right-turn mode.

FIG. 9 shows the vehicle of FIG. 4 with the steering control system in a normal-flow, left-turn mode.

FIG. 10 shows the vehicle of FIG. 4 with the steering control system in an amplified-flow, left-turn mode.

### DETAILED DESCRIPTION

Reference will now be made in detail to the exemplary aspects of the present disclosure that are illustrated in the accompanying drawings. Wherever possible, the same reference numbers will be used throughout the drawings to refer to the same or like structure. The disclosed technology may be utilized with variable rate steering systems available from a variety of manufacturers, such as the Q-amp steering system manufactured by Eaton Corporation.

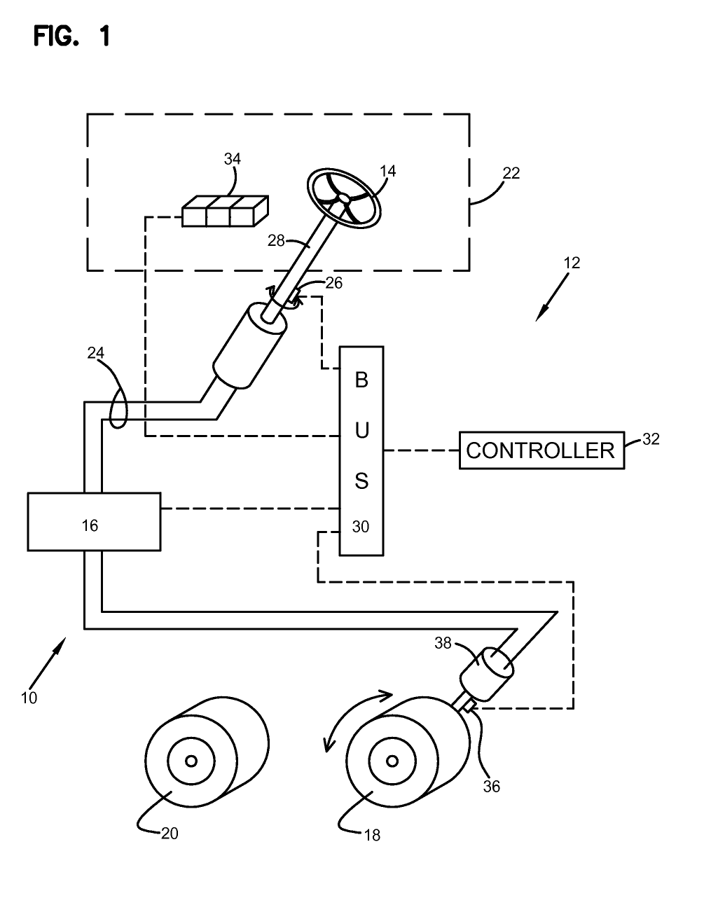

FIG. 1 depicts a schematic diagram of a variable rate steering and visual feedback system 10 for a vehicle 12. Typically, the type of vehicles that may benefit from the technology disclosed herein include non-articulating vehicles, such as lift trucks, mining vehicles, heavy construction vehicles, or any other vehicle where both lower steering responsiveness and higher steering responsiveness are desirable depending upon on the steering operation being conducted. Lower steering responsiveness decreases steering sensitivity thereby allowing an operator to easily maintain a relatively straight path. This is advantageous when the vehicle is being driven at higher speeds. Higher steering responsiveness allows the operator to make sharp turns with minimal effort/movement. This reduces operator fatigue resulting from maneuvers that involve repetitive turning of the steering wheel (e.g., low speed maneuvers in close quarters). Additionally, vehicles where wheel position cannot be visually confirmed due to wheel position (e.g., rear-steered lift trucks, where wheels are located behind the operator) or due to vehicle size (e.g., extra-large mining trucks) would benefit from this system. In general, the steering and visual feedback system 10 described herein may be used on any vehicle 12 that includes a steering element 14 (i.e., a steering wheel), a hydraulic circuit 16, and one or more steered wheels 18. The steered wheels 18 may be driven, but more typically, one or more unsteered wheels 20 function as drive wheels, providing a motive force to the vehicle 12. The steered wheels 18 may be rotated based on a rotational movement of the steering element 14. The rotation of the steering element 14 is translated by the hydraulic circuit 16 into pivoting movement of the steered wheel 18, relative to the body of the vehicle 12.

The steering element 14 may be a steering wheel or steering handle typically located in an operator compartment or station 22. The steering wheel 14 is connected to the hydraulic circuit 16. For example, the steering wheel 14 can be mechanically connected to a control valve of the hydraulic circuits by a shaft, linkage or other structure. Although not required, one or more detectors or sensor 26 that detect a rotational speed and/or angle of rotation of the steering element 14 may be included on an associated steering column 28. Signals from the detector 26 may be sent via a bus 30 (e.g., a controller in area network (CANBUS)) to a controller 32. Alternatively, the detector signals may be sent directly to the controller 32. The signal may also be transmitted in a more traditional analog communication method. In many vehicles, buses are installed during manufacture, making the disclosed system ideal for retrofit applications, requiring only electrical connections to the existing vehicle network. If a detector 26 is utilized, signals sent therefrom may be used to calculate the wheel position, either to replace or supplement the steered wheel position as detected by a wheel position detector 36, described below.

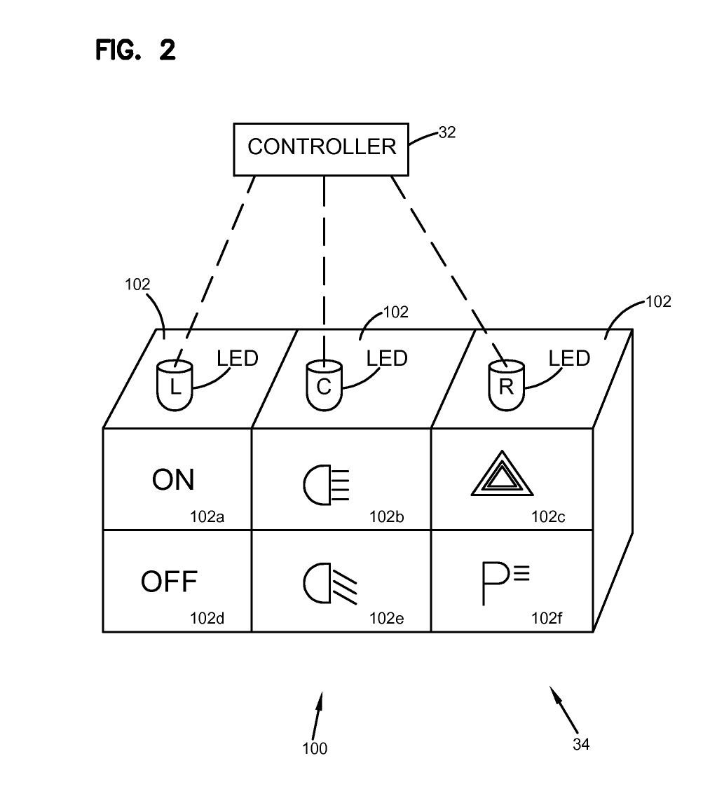

An indicator 34 is also located within the operator station 22, at a location where the indicator display can be readily viewed by the operator when seated at the operator station. The indicator 34 provides a visual indication to the operator representative of a steered position of the steered wheels 18. Thus, the operator can readily ascertain whether the steered wheels 18 are centered, angled left or angled right. The indicator 34 may be integrated into other elements of a control panel or may be a discrete panel or set of lights. In other embodiments the indicator can be a display on a screen such as a digital display (e.g., a flat screen display monitor). In one embodiment, multiple light emitting diodes (LEDs) may be incorporated into switches present on the vehicle control panel. For example, many lift trucks are now manufactured with banks of toggle switches that are used for control of lights, environmental conditions (i.e., seating heating systems), safety systems (hazard or warning lights), or other components or accessories. These switches include a plurality of LEDs centrally located therein, such that the position of the steered wheels 18 may be visually indicated to the operator. FIG. 2 depicts schematically such an indicator 34.

FIG. 2 depicts a bank 100 of toggle switches 102 that include controls for: (left-to-right, top row) ACCESSORY ON 102a, HIGH-POWER LIGHTS 102b, HAZARD FLASHER 102c, as well as (left-right, bottom row) ACCESSORY OFF 102d, LOW-POWER LIGHTS 102e, PARKING LIGHTS 102f. In the proposed application, LEDs L, C, R may be installed within the housing of each switch 102, and connected to the controller 32, either directly or via the bus depicted in FIG. 1. In the depicted embodiment, the controller 32 selectively illuminates any of the three LEDs L, C, R to indicate the position of the steered wheels. LED L indicates that the wheels are pointing toward the left, LED C indicates that the wheels are centered, and LED R indicates that the wheels are pointing right. As each LED is energized, the associated switch 102 is illuminated, providing the operator with a visual indication of the steered position of the wheels 18. Of course, banks of greater than three switches may be utilized, providing greater resolution for the visual indication system. In certain embodiments, each LED may have a specific lens color, such that each LED emits a different color. In other embodiments, LED C may emit a specific color (green, for example), while LEDs L, R may emit a different color (red, for example).

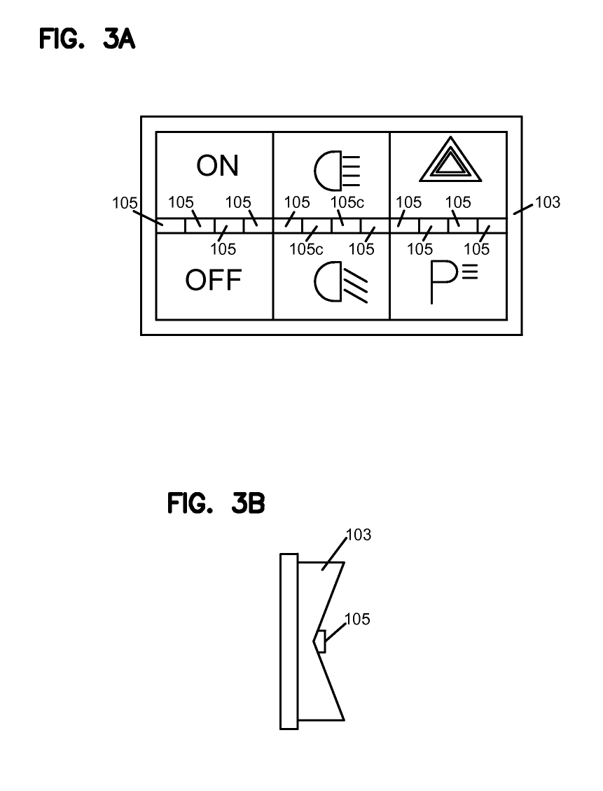

In another embodiment, depicted in FIGS. 3A and 3B, switches 103 may be used with four segment LEDs 105 integrated into each switch. The switches 103 may be provided in a module of three switches such that twelve LED segments are available to communicate steered wheel position to the operator thereby providing a higher degree of resolution. Illuminating two center LEDs 105c of the center switch 103 provides an indication that the steered wheels 18 are aligned. Illuminating LEDs 105 to the left of the two center LEDs 105c indicates that the steered wheels 18 are aligned left with the LEDs being illuminated further leftward of the center LEDs 105c as the degree of leftward angling increases. Illuminating LEDs 105 to the right of the two center LEDs 105c indicates that the steered wheels 18 are angled right with the LEDs 105 being illuminated further rightward of the center LEDs as the degree of rightward angling increases. Returning to FIG. 1, other visual indicators 34 may include liquid crystal displays, rows of LEDs discrete from other control or display components, visual screens, or a gauge with a needle indicator. In a screen having sufficient resolution, the indicator may present information as a bar graph or as images of one or more wheels pivoting based on the actual position of the steered wheels 18. Once the wheels are centered, the wheels and/or display may change color to indicate same to the operator. Also, although the indicator depicted in FIG. 2 identifies only three wheel positions, resolution may be enhanced based on the resolution of a wheel position detector 36, the other detectors (the operation of which is described below), and/or the controller 32 that processes the information sent from the various sensors. Accordingly, wheel position may be indicated in various increments. The embodiment of FIG. 2 utilizes a substantially three-position system, where any position off of center will illuminate a different LED. Indication of wheel position in increments of thirty (30) degrees, fifteen (15) degrees, five (5) degrees, and one (1) degree are also contemplated. Different degrees of resolution can be achieved with different visual indicators. The variable rate steering system 10 includes a hydraulic cylinder 38 for changing a steered position of the steered wheel 18 in response to rotational movement of the steering element 14. An exemplary hydraulic circuit that may be used in a variable rate steering system is disclosed in U.S. Pat. No. 4,759,182, the disclosure of which is incorporated by reference herein in its entirety. In general, the hydraulic circuit 16 delivers a volume of hydraulic fluid to the hydraulic cylinder 38, depending on an operational mode. In general, the steering system 10 has two operational modes such as a normal flow mode and an amplified flow mode. The mode in which the system 10 is operating can be dependent upon a rate of rotation of the steering element 14. The normal flow mode is typically used for steering the vehicle at high vehicle speeds, where the rate of rotation of the steering element is fairly low and less steering sensitivity is desired. In this mode, the hydraulic circuit 16 delivers a first volume of fluid to the hydraulic cylinder 38 per degree of rotation of the steering element 14. In certain embodiments, the normal flow mode operates at a rotational speed of the steering element 14 of up to about 10 rpm. That is, if the steering element 14 is rotated at a rotational rate less than or equal to 10 rpm, the hydraulic circuit 16 will deliver a consistent volume of fluid to the hydraulic cylinder 38, thus rotating the steered wheels 18 accordingly. In one embodiment of a steering system 10 for lift trucks, 440 cubic inches of hydraulic fluid may be delivered in 4.4 turns of the steering element 14, lock-to-lock. A lock position is reached when the steered wheel reaches the mechanical stop. Further rotation of the steering element 14 in the given direction is hydraulically stopped when the lock position is reached.

In the amplified flow mode, the hydraulic circuit 16 delivers a second volume of fluid to the hydraulic cylinder 38 per degree of rotation of the steering element 14. The second volume is larger than the first volume. In one embodiment, the system operates in the amplified flow mode when the rotational speed of the steering element 14 is in the range of 10 rpm to about 60 rpm. As the rotational speed of the steering element 14 increases, so does the flow of hydraulic fluid. In this mode, 440 cubic inches of hydraulic fluid is again delivered to the hydraulic cylinder 38, in only 2.2 turns of the steering element 14, lock-to-lock. Accordingly, the operator is able to deliver the same volume of fluid to the hydraulic cylinder 38 with fewer turns of the steering element 14, and therefore, with less operator fatigue. In that regard, the variable rate steering system 10 is more sensitive when the steering element 14 is rotated at the higher rotational speed. Of course, the steering system 10 may be configured such that the first and second modes of operation are based on rotational rates other than 10 rpm and 60 rpm. Moreover, the flow amplification rate need not be set to one rate, but instead can vary with the rotational speed of the steering element or other factors (i.e., variable amplification rates can be used/provided).

The wheel position sensor or detector 36 may be a kingpin sensor, cylinder position sensor, limit switch or other switch, a solenoid, or other type of mechanical or electrical device that can detect a position of the steered wheel 18. In the case of lift trucks that include a single steered wheel located in a rear of the vehicle, a single detector 36 may sufficient. In vehicles with multiple steered wheels, one or more detectors may be used. In the case of multiple detector systems, the signals indicative of the positions of each steered wheel 18 may be averaged or otherwise processed to determine if an error or wheel misalignment is present. Faulty or inconsistent signals may be communicated to the controller 36, which may, in turn, alert the operator.

One embodiment of the basic visual feedback system includes a controller, a wheel position detector 36, and an indicator. In other embodiments, detectors present on other system components may be used to either replace or supplement the information sent by the wheel position detector 36. For example, a wheel position detector element instead may be a circuit, either integral with the controller or stand-alone, that calculates a position of the wheels based on signals from other detectors. In one embodiment, signals sent from the sensor 26 located on the steering column 28 may correspond to a rate of rotation and/or an angular rotation of the steering element. These signals may be used to calculate a resulting steered position of the wheel. Since the amount of hydraulic fluid delivered to the hydraulic cylinder is based on a rate of rotation and angular rotation of the steering element, the resulting position of the steered wheel may be calculated based on signals sent from the detector 26.

In another embodiment, one or more flow sensors located in the hydraulic circuit 16 may be used to calculate fluid flow rate and/or volume to the hydraulic cylinder. Signals from these flow sensors may be sent to a circuit integral with the controller or stand-alone, and used to calculate the steered position of the wheels. Certain embodiments of the steering and visual feedback system may utilize one or more of wheel position detectors 36, steering element sensors 26, and hydraulic circuit 16 sensors. The signals sent from each type of sensor and the information calculated therefrom may be used to supplement or replace information received from another sensor. For example, differences between a detected wheel position (from, e.g., the wheel position detector 36) and a calculated wheel position (from, e.g., the steering column detector 26) may generate an error message that may be communicated to the vehicle operator by the controller. Alternatively or additionally, one or more wheel position calculation systems (i.e., based on the steering element sensor 26 or hydraulic circuit 16 sensor) may be used if the wheel position detector 36 fails.

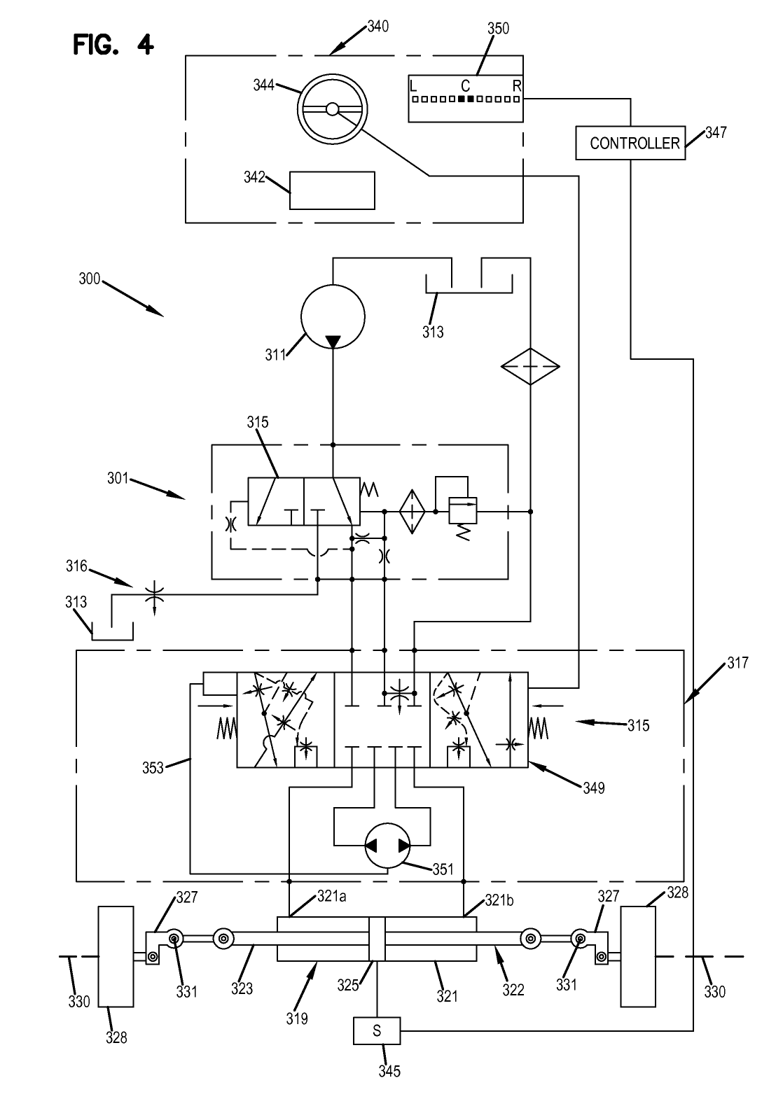

The visual feedback system has particular advantages when used in conjunction with variable rate steering systems, when the steered wheel position may be unknown to the vehicle operator, due to the operation of the variable rate system. The visual feedback system may be used in conjunction with both variable rate steer-by-wire or variable rate hydraulic systems. Both electrohydraulic actuation and electric actuation steer-by-wire systems may be used. In electrohydraulic steer-by-wire systems, an electronic device interfaces with the steering element (i.e., the steering wheel). Signals sent from this electronic device are sent to a controller that actuates a hydraulic valve, based on the variable rate algorithms contained within the controller. The valve controls flow through a hydraulic circuit that in turn actuates a hydraulic cylinder at a steered wheel. In electric steer-by-wire systems, the electronic device associated with the steering element delivers signals to a controller that in turn controls the position of the steered wheel by energizing a motor. Again, the controller energizes the motor based on variable rate algorithms. An exemplary embodiment of a hydraulic variable rate steering system is described below with regard to FIGS. 4-10.

FIG. 4 schematically illustrates a vehicle 300 having a vehicle hydrostatic steering system 301 and steering feedback in accordance with the principles of the present disclosure. The hydrostatic steering system includes a fluid pump 311 that draws hydraulic fluid from a system reservoir 313. A control valve 315 apportions the flow of hydraulic fluid output from the pump 311 between a primary steering circuit 315 and an auxiliary circuit 316. The primary steering circuit 315 includes a fluid controller 317 that controls fluid flow to and from a steering hydraulic cylinder 319. For example, the fluid controller 317 controls fluid communication between the fluid pump 311 and the hydraulic cylinder 319, and also controls fluid communication between the hydraulic cylinder 319 and the reservoir 313.

The steering hydraulic cylinder 319 includes a cylinder body 321 and a piston 322 that slides back and forth within the cylinder body 321. The piston 322 includes a piston rod 323 and a piston head 325. The cylinder body 321 defines ports 321a, 321b on opposite sides of the piston head 325. The piston rod 323 has opposite ends that are pivotally connected to wheel hubs 327 by pivot linkages. Wheels 328 are mounted to the wheel hubs 327 and are rotatable about generally horizontal rotation axes 330. The wheel hubs 327 define generally vertical rotation axes 331 that allow the wheel hubs 327 and the wheels 328 connected thereto to be pivoted/rotated relative to the vehicle 300. The steering hydraulic cylinder 319 provides the motive force for pivoting the wheel hubs 327 about the axes 331 to provide steering of the vehicle 300.

Referring still to FIG. 4, the vehicle 300 includes an operator station 340 having an operator seat 342. A steering wheel 344 is positioned in front of the operator's seat 342. In one embodiment, the vehicle 300 is a lift truck in which a steered wheel or wheels 328 are provided at the back of the vehicle 300. Thus, when seated at the operator seat 342, the operator has a normal field of vision oriented in a forward direction such that the wheels 328 are not visible. In this regard, a steered wheel position indicator 350 is provided at the operator's station 340 for allowing the operator to readily ascertain the steered position of the wheels 328. A wheel position sensor 345 senses the steered position of the wheels 328 and generates data representative of the steered position of the wheels. In one embodiment, the wheel position sensor 345 senses an axial position of the piston rod 323 or a rotational position of the wheels and/or the wheel hubs. The data representative of the steered position of the wheels 328 is communicated to an electronic control unit 347. The electronic control unit 347 interfaces with the steered wheel position indicator 350 and uses the data from the steered wheel position indicator to provide a suitable display at the steered wheel position indicator 350 which is representative of the sensed position of the steered wheel/wheels 328.

The fluid controller 317 may be of the general type illustrated and described in U.S. Pat. No. 4,759,182, the disclosure of which is hereby incorporated by reference herein in its entirety. Other information relating to the fluid controller 317 may be found in U.S. Pat. No. Re. 25,126 and U.S. Pat. No. 4,109,679, the disclosures of which are hereby incorporated by reference herein in their entireties.

The fluid controller 317 can include a valving arrangement 349 that is operable in various positions. In certain embodiments, the valving arrangement 349 can include a rotary main spool that is mechanically coupled to the steering wheel 344 such that rotation of the steering wheel 344 causes rotation of the rotary main spool. The valving arrangement 349 can also include a follow-up member capable of relative rotation of movement relative to the main rotary spool. The valving arrangement 349 can further include a fluid meter 351 that measures the amount of fluid that is communicated to hydraulic cylinder 319 through normal-flow, flow paths of the fluid controller 317, and that also provides follow-up movement of the follow-up member. Such follow-up movement functions to return the valving arrangement 349 to a neutral position after an amount of fluid has been communicated to the steering cylinder 319. This follow-up movement is achieved by means of a mechanical follow-up connection 353.

It will be appreciated that the fluid controller 317 is operable and a normal-flow mode and an amplified-flow mode. The particular mode in which the fluid controller 317 is operating is dependent upon the magnitude/degree of valve displacement between the main rotational spool and the follow-up member. The magnitude/degree of valve displacement between the main rotational spool and the follow-up member is dependent upon the speed at which the steering wheel 344 is rotated. Thus, the speed at which the steering wheel 344 is rotated dictates the degree of valve displacement of the valving arrangement 346 and thereby determines whether the fluid controller 317 is operating in the normal-flow mode or the amplified-flow mode.

In certain embodiments, the fluid controller 317 operates in the normal-flow mode when the steering wheel 344 is rotated at a rotational speed less than 10 rotations per minute, and operates in the amplified-flow mode when the steering wheel 344 is rotated at a speed equal to or greater than 10 rotations per minute. Of course, these ranges are provided by way of example, and other ranges could be used as well for delineating the normal-flow mode from the amplified-flow mode.

FIG. 4 shows the vehicle 300 with the fluid controller 317 in a neutral position and the wheels 328 in a centered orientation. When in the neutral position, the fluid controller 317 blocks fluid communication between the steering cylinder 319 and the pump 311, and also blocks fluid communication between the steering cylinder 319 and reservoir 313. As shown in FIG. 4, central LEDs of the steering wheel position indicator 350 are illuminated to provide an indication that the wheels 328 are in the centered orientation.

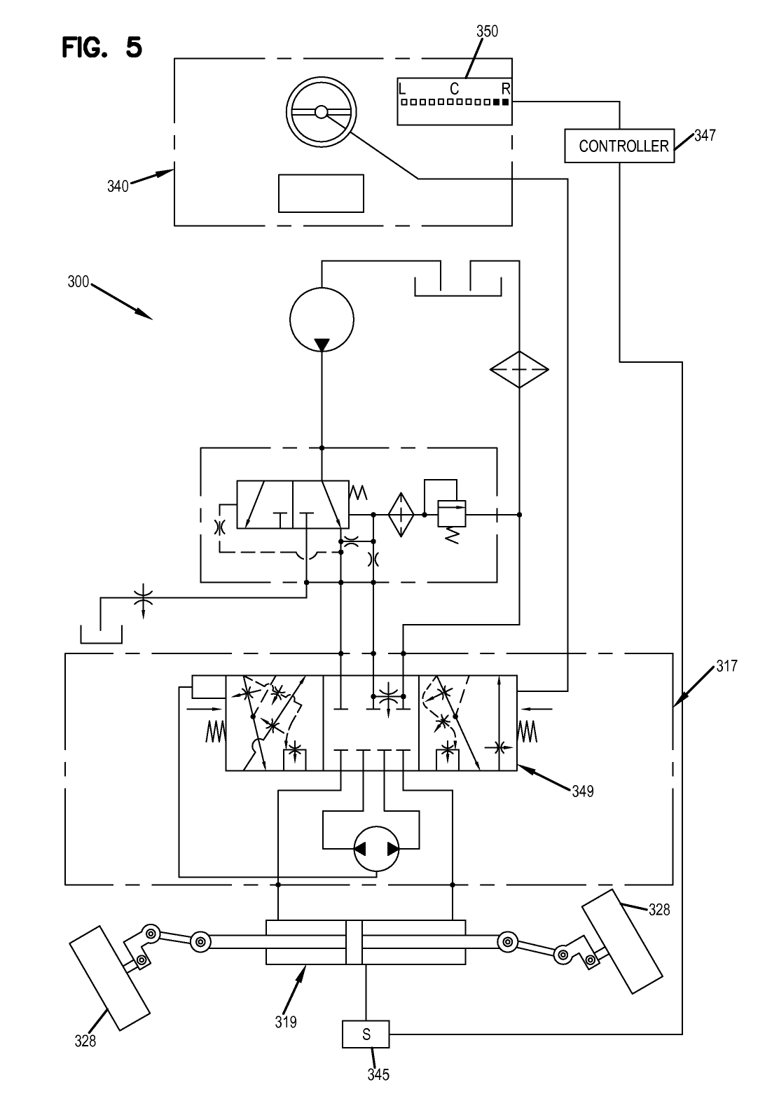

FIG. 5 shows the vehicle 300 with the fluid controller 317 in the neutral position and the wheels 328 turned/angled to a full right-turn orientation. As shown in FIG. 5, right-most LEDs of the steering wheel position indicator 350 are illuminated to provide an indication that the wheels 328 are in the full right-turn orientation.

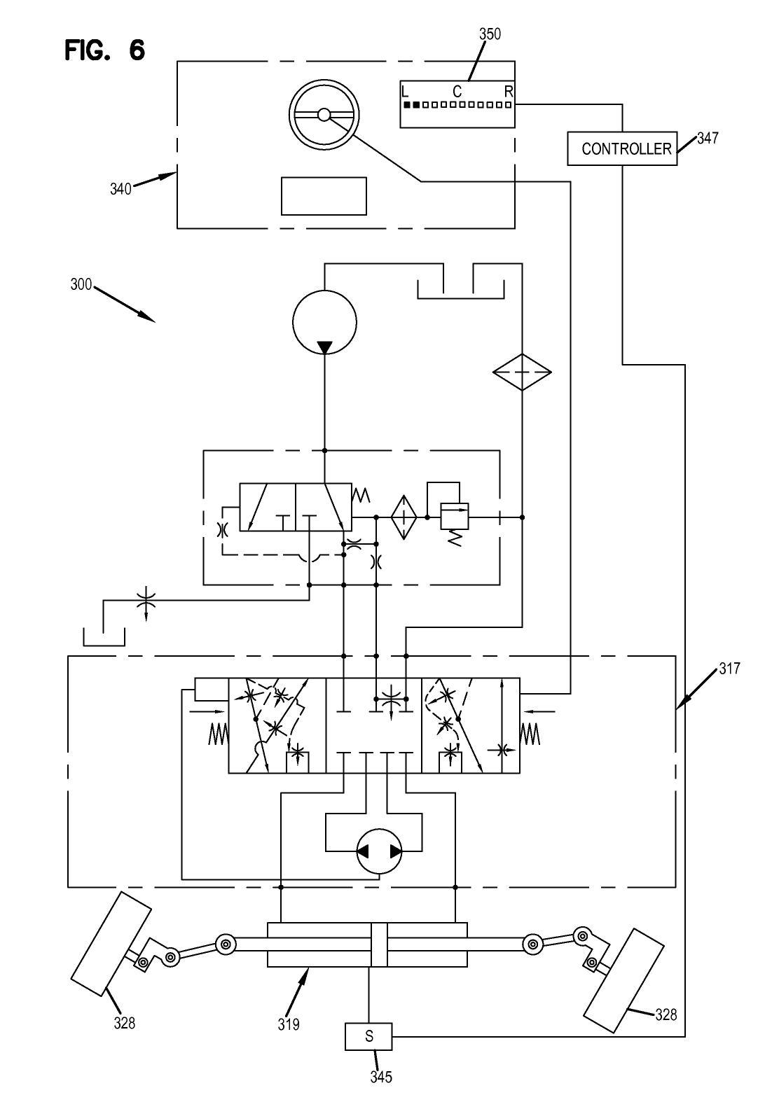

FIG. 6 shows the vehicle 300 with the fluid controller 317 in the neutral position and the wheels 328 pivoted/turned to a full left-turn orientation. As shown in FIG. 6, left-most LEDs of the steering wheel position indicator 350 are illuminated to provide an indication that the wheels 328 are in the full left-turn orientation.

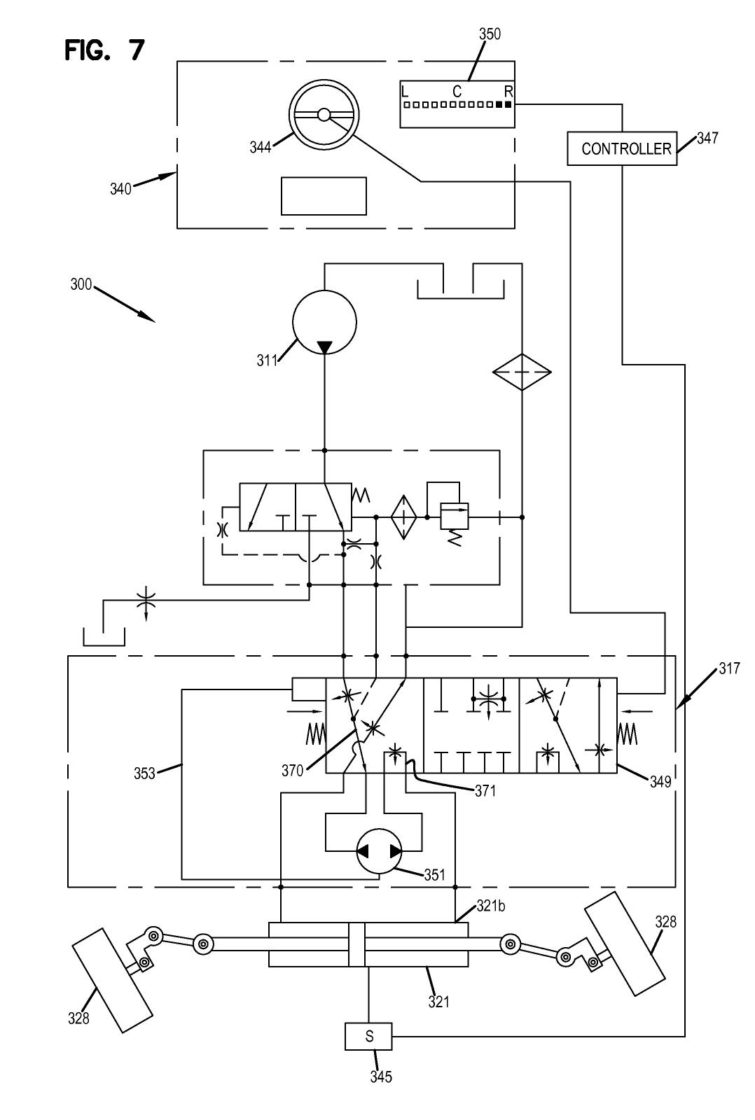

FIG. 7 shows the vehicle 300 with the wheels 328 reaching the full right-turn orientation and the fluid controller 317 in a normal-flow, right-turn steering mode. In this mode, a normal-flow, right-turn flow line 370 provides fluid communication between the fluid pump 311 and the fluid meter 351, and flow line 371 provides fluid communication between the fluid meter 351 and the right port 321b of the cylinder body 321. In such a configuration, all of the flow provided to the cylinder body 321 passes through the fluid meter 351 and assists in returning the follow-up member to the neutral position through the mechanical follow-up connection 353. Thus, FIG. 7 is representative of the system 301 operating in the normal-flow mode while the operator turns the vehicle right at a relatively slow steering wheel turn speed.

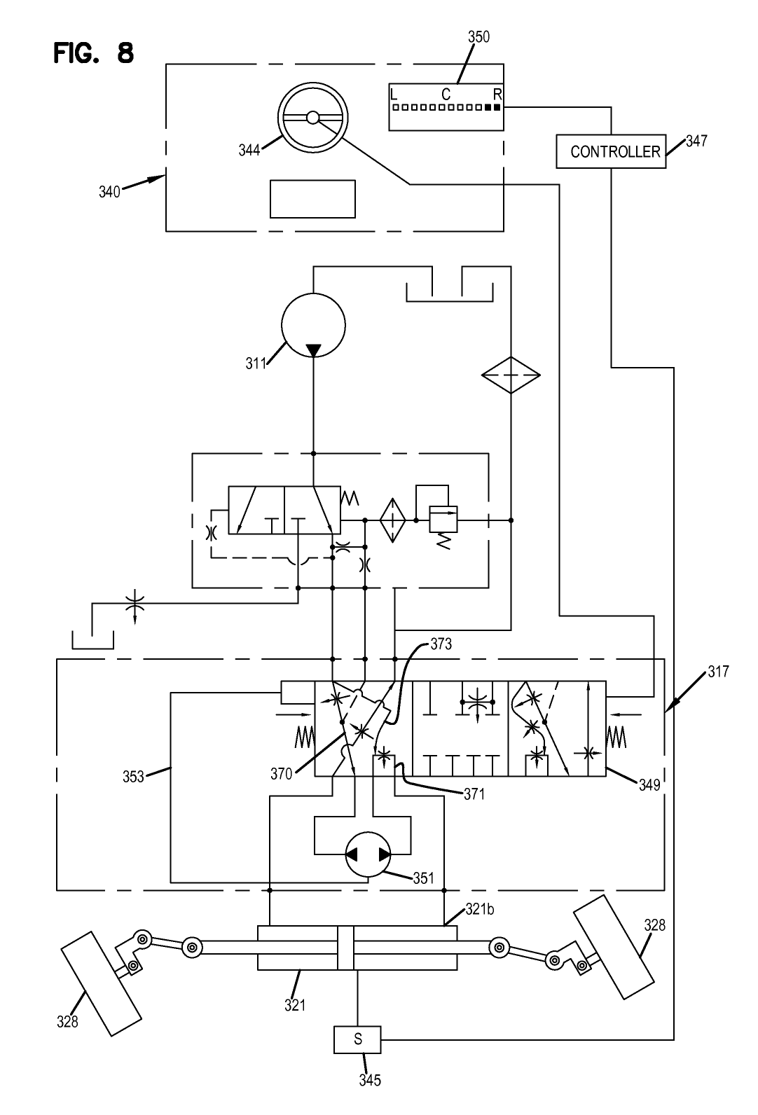

FIG. 8 shows the wheels 328 reaching the full right-turn orientation while the fluid controller 317 is in an amplified-flow, right-turn steering mode. In the amplified-flow, right-turn steering mode, the normal flow line 370 provides fluid communication between the fluid pump 311 and the fluid meter 351. Also, an amplification-flow, right-turn flow line 373 provides fluid communication between the fluid pump 311 and the flow line 371 thereby by-passing the fluid meter 351. In this way, an amplified flow volume is provided to the right port 321b steering cylinder 319 per degree of rotation of the steering wheel 344 as compared to when the fluid controller 317 is operating in the normal-flow, right-turn mode of FIG. 7. Thus, FIG. 8 is representative of the system 301 operating in the amplified-flow mode while the operator turns the vehicle right at a relatively high steering wheel turn speed.

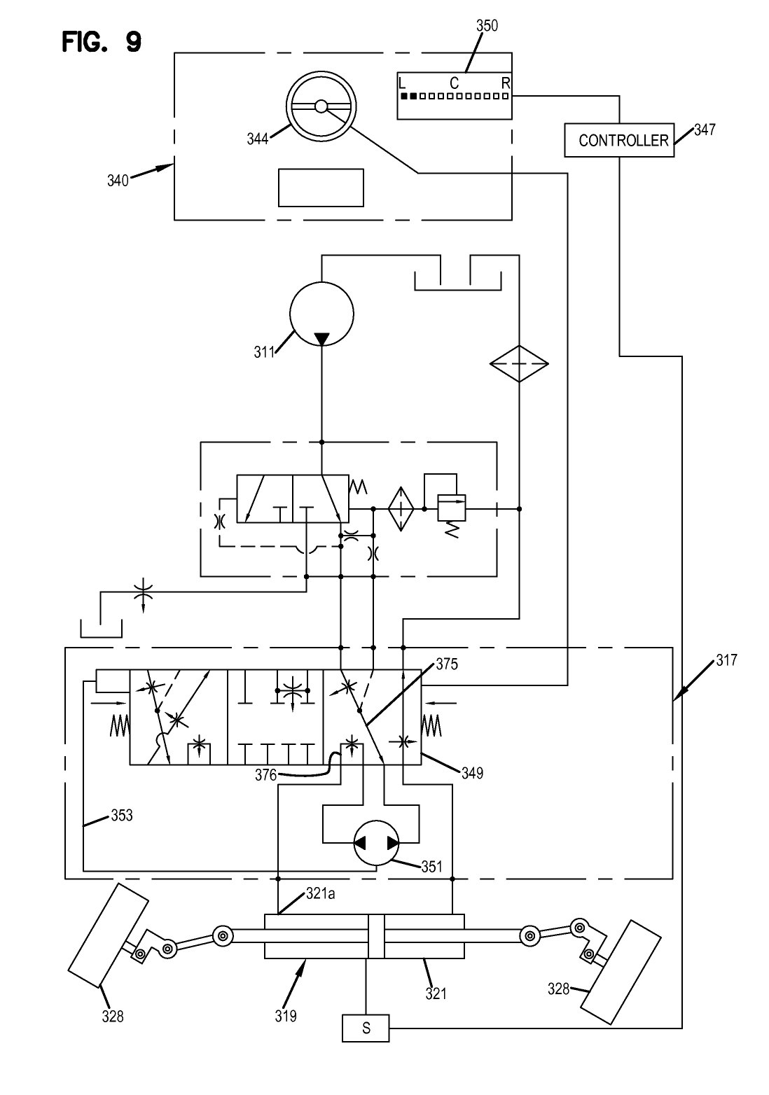

FIG. 9 shows the vehicle 300 with the wheels 328 reaching the full left-turn orientation and the fluid controller 317 in a left-turn, normal-flow steering mode. In this mode, a left-turn, normal-flow flow line 375 provides fluid communication between the fluid pump 311 and flow meter 351. Also, a flow line 376 provides fluid communication between the flow meter 351 and the left port 321a of the cylinder body 321. In this mode of operation, all of the hydraulic fluid provided to the left side of the cylinder body 321 passes through the fluid meter 351 and is used to return the follow-up member to the neutral position. Thus, FIG. 9 is representative of the system 301 operating in the normal-flow mode while the operator turns the vehicle left at a relatively slow steering wheel turn speed.

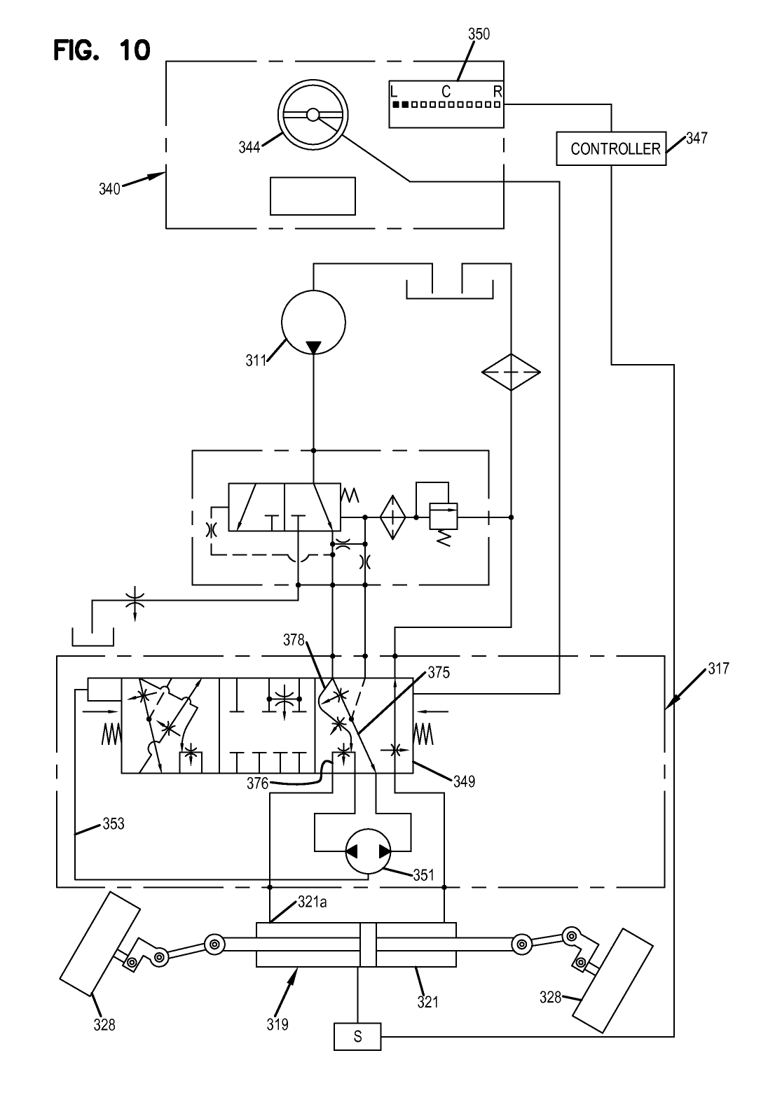

FIG. 10 shows the vehicle 300 with the wheels 328 reaching the full left-turn orientation and the fluid controller 317 in a amplified-flow, left-turn steering mode. In this mode, the left-turn, normal-flow flow line 375 provides fluid communication between the fluid pump 311 and the flow line 376. Also, an amplified-flow, left-turn flow line 378 provides fluid communication between the fluid pump 311 and the flow line 376. The amplified-flow, left-turn flow line 378 bypasses the fluid meter 351. In this way, a larger volume of hydraulic fluid is provided to the left port 321a of the steering cylinder 319 per degree of rotation of the steering wheel 344 when the fluid controller 317 is in the amplified-flow, left-turn mode as compared to the normal-flow, left turn mode of FIG. 9. Thus, FIG. 10 is representative of the system 301 operating in the amplified-flow mode while the operator turns the vehicle left at a relatively high steering wheel turn speed.

The visual indication system described above may be sold as a kit, either in a single package or in multiple packages. A kit may include a wheel position sensor, an indicator, and a controller. Alternatively, the controller may be sold separately and users may then obtain the various sensors and indicators (i.e., LEDs) separately from a third party or from the controller supplier. If desired, control wiring may be included, although instructions included with the kit may also specify the type of wiring required based on the particular installation. Compatible bus systems may also be identified with the controller.

Additionally, the controller may be loaded with the necessary software or firmware required for use of the system. The control algorithm technology described herein can be realized in hardware, software, or a combination of hardware and software. The technology described herein can be realized in a centralized fashion in one computer system or in a distributed fashion where different elements are spread across several interconnected computer systems. Any kind of computer system or other apparatus adapted for carrying out the methods described herein is suitable. A typical combination of hardware and software can be a general purpose computer system with a computer program that, when being loaded and executed, controls the computer system such that it carries out the methods described herein. Since the technology is contemplated to be used on vehicles, however, a stand-alone hardware system including the necessary sensors is desirable. More complicated vehicles, such as extra-large mining vehicles that may be operated remotely may utilize control systems connected to external computer control systems.

The technology described herein also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While there have been described herein what are to be considered exemplary and preferred embodiments of the present technology, other modifications of the technology will become apparent to those skilled in the art from the teachings herein. The particular methods of manufacture and geometries disclosed herein are exemplary in nature and are not to be considered limiting. It is therefore desired to be secured in the appended claims all such modifications as fall within the spirit and scope of the technology. Accordingly, what is desired to be secured by Letters Patent is the technology as defined and differentiated in the following claims, and all equivalents.

What is claimed is:

1. A steering control system for use on a vehicle having an operator station including a steering wheel that is turned by an operator of the vehicle to cause a steered wheel of the vehicle to pivot relative to a main body, the steering control system including a hydraulic cylinder for changing a steered position of the steered wheel in response to movement of the steering wheel, the steering control system comprising:
a hydraulic circuit arrangement that varies a volume of hydraulic fluid flow provided to the hydraulic cylinder per degree of rotation of the steering wheel based on a rotational speed of the steering wheel, the hydraulic circuit arrangement directing a first volume of hydraulic fluid to the hydraulic cylinder per degree of rotational movement of the steering wheel when the steering wheel is rotated at a first rotational speed, the hydraulic circuit arrangement directing a second volume of hydraulic fluid to the hydraulic cylinder per degree of rotational movement of the steering wheel when the steering wheel is rotated at a second rotational speed, the second rotational speed being larger than the first rotational speed and the second volume of hydraulic fluid being larger than the first volume of hydraulic fluid, wherein the steering control system is more sensitive when the steering wheel is rotated at the second rotational speed than the first rotational speed;
a sensor for sensing the steered position of the steered wheel;
a display positioned at the operator station the display providing an indication of the steered position of the steered wheel; and
a controller that interfaces with the hydraulic circuit arrangement, the sensor and the display.

2. The steering control system of claim 1, wherein the vehicle is a non-articulated vehicle.

3. The steering control system of claim 1, wherein the steering control system stops rotational movement of the steering wheel in one direction when a maximum amount of hydraulic fluid has been provided to one side of the hydraulic cylinder.

4. The steering control system of claim 1, wherein the operator station includes a bank of toggle switches for controlling various components of the vehicle, wherein the bank of toggle switches includes centrally located light emitting diodes that define a row of light emitting diodes, and wherein light emitting diodes of the row of light emitting diodes are selectively illuminated based on the steered position of the steered wheel such that the row of light emitting diodes functions as the display.

5. The steering control system of claim 1, wherein the steered wheel is outside a normal field of vision of the operator when the operator is seated at the operator station.

6. The steering control system of claim 5, wherein the steered wheel is behind the operator station.

7. A variable rate steering system for a vehicle having a steering element and at least one wheel actuated by a hydraulic cylinder, the variable rate steering system comprising:
a fluid circuit for translating a rotation of the steering element to the at least one wheel by delivering a volume of hydraulic fluid to the hydraulic cylinder, wherein the fluid circuit delivers a first volume to the hydraulic cylinder based on a first rate of rotation of the steering element, and wherein the fluid circuit delivers a second volume to the hydraulic cylinder based on a second rate of rotation of the steering element, wherein the second volume is greater than the first volume;
a wheel position detection element;
an indicator; and
a controller that interfaces with the wheel position detection element and the indicator.

8. The variable rate steering system of claim 7, wherein the wheel position detection element comprises a kingpin sensor.

9. The variable rate steering system of claim 7, wherein the wheel position detection element comprises at least one of a solenoid and a switch.

10. The variable rate steering system of claim 7, wherein the wheel position detection element comprises a circuit for calculating a wheel position based at least in part on a rate of rotation of the steering element and an angular rotation of the steering element.

11. The variable rate steering system of claim 7, wherein the wheel position detection element comprises a circuit for calculating a flow rate of the hydraulic fluid within fluid circuit.

12. The variable rate steering system of claim 10, wherein the circuit is integral with the controller.

13. The variable rate steering system of claim 7, wherein the indicator comprises a plurality of light emitting elements, and wherein the controller illuminates at least one of the light emitting elements based at least in part on a steered position of the wheel.

14. The variable rate steering system of claim 13, further comprising a plurality of toggle switches, wherein at least one light emitting element corresponds to each of the plurality of toggle switches, such that illumination of a selected light emitting element illuminates a corresponding toggle switch.

15. The variable rate steering system of claim 13, wherein the plurality of light emitting elements are arranged in a row.

16. The variable rate steering system of claim 7, wherein the indicator comprises a display.
